(19) United States
(12) Patent Application Publication
(10) Pub. No.: US 2017/0294242 A1
(43) Pub. Date: Oct. 12, 2017

(54) IN SITU PROBE FOR MEASUREMENT OF LIQUIDUS TEMPERATURE IN A MOLTEN SALT REACTOR

(71) Applicant: Elysium Industries Limited, Vancouver (CA)

(72) Inventors: Michael Simpson, Salt Lake City, UT (US); Andrew McCall Dodson, Malden, MA (US)

(21) Appl. No.: 15/342,913

(22) Filed: Nov. 3, 2016

Related U.S. Application Data
(63) Continuation-in-part of application No. 15/342,509, filed on Nov. 3, 2016.
Application No. 15/342,509 is a continuation-in-part of application No. 15/342,513, filed on Nov. 3, 2016.
(60) Provisional application No. 62/251,410, filed on Nov. 5, 2015.
(60) Provisional application No. 62/251,365, filed on Nov. 5, 2015.
(60) Provisional application No. 62/259,420, filed on Nov. 24, 2015.

(51) Int. Cl. G21C 17/112; G01N 1/12; G21C 17/022

(52) U.S. Cl. CPC G21C 17/112; G21C 17/022; G01N 1/12

(57) ABSTRACT

A method for in-situ measuring of a liquidus temperature of a supply of the molten salt, includes withdrawing a sample of the molten salt from the supply, placing it into a sample container, and cooling the sample of the molten salt from a first temperature above the liquidus temperature of the molten salt to a second temperature at which at least a portion of the sample of the molten salt solidifies. The method includes taking a plurality of temperature measurements of the sample of the molten salt during cooling of the sample and determining the liquidus temperature of the molten salt from the measurements. The sample of the molten salt is heated from the second temperature to the first temperature and returned to the supply of the molten salt.

### CROSS-REFERENCE TO RELATED APPLICATIONS

The application claims the benefit of U.S. Application No. 62/251,410, filed Nov. 5, 2015, and U.S. Application No. 62/251,365, filed Nov. 5, 2015, the contents of which are incorporated herein by reference in their entireties.

### FIELD OF INVENTION

The present invention relates generally to molten salt nuclear reactors and more specifically to an in situ probe for measurement of liquidus temperature in a molten salt reactor.

### BACKGROUND

To improve on previous Light Water Reactor (LWR) technologies, Molten Salt Reactors (MSRs) have been researched since the 1950s. MSRs are a class of nuclear fission reactors in which the primary coolant, or even the fuel itself, is a molten salt mixture (e.g., fluoride or chloride salt). Compared to LWRs, MSRs offer projected lower per-kilowatt hour (kWh) levelized cost, comparatively benign fuel and waste inventory composition, highly efficient fuel utilization, and a combination of higher accident resistance with lower worst-case accident severity (due to more benign inventory composition). In various designs, the innate physical properties of MSRs passively and indefinitely remove decay heat and bind fission products.

Early development of MSRs was primarily from the 1950s to 1970s, but a renewed interest in MSRs has recently developed. However, since less development effort has been devoted to MSRs than to other reactor types, various technical challenges remain to be solved in order to develop a commercially viable system.

One of the challenges of operating an MSR arises from the fact that it is important to maintain the molten salt entirely in the liquid phase during the operation. Therefore, the temperature of the system must always be kept above the liquidus temperature of the molten salt. The liquidus temperature (or liquidus, T_{liq}) of a material specifies the temperature above which the material is completely liquid, and the maximum temperature at which crystals can co-exist with the melt in thermodynamic equilibrium (Askeland et al., Essentials of Materials Science and Engineering. Cengage Learning, 2014, p. 329). However, the MSR salt contains many constituents, and the concentrations of these constituents vary significantly during operation, resulting in phase behavior that is difficult to predict. In particular, variations in composition can alter the liquidus temperature (i.e., solidification temperature) of the molten salt. Changes of a molten salt composition during system operation will be difficult to predict or monitor (e.g., abnormal operational situations may cause the composition to go outside of the expected range, which may lead to salt freezing or precipitation). Therefore, molten salts with changing compositions have not been widely used in commercial reactor systems.

To date, primary interest in molten salts for nuclear energy applications have been focused on pyroprocessing of metallic or oxide spent fuels, which also needs to anticipate how composition changes affect the salt phase behavior. This, however, requires a multi-year study to develop the theoretical foundation and obtain the empirical data needed to predictively model variations in phase properties for a given system (e.g., for a given MSR). Previous studies have used thermal analysis instruments to measure liquidus/solidus temperatures of small frozen samples of salts (Gutknecht, Fredrickson, and Utgikar, “Thermal Analysis of Surrogate Simulated Molten Salts with Metal Chloride Impurities for Electrorefining Used Nuclear Fuel,” No. INUEXT-11-23511, Idaho National Laboratory, 2012; Sridharan, et al., “Thermal Properties of LiCl-KC1 Molten Salt for Nuclear Waste Separation,” Final Project Report, NEUP Project No. 09-780, Nov. 30, 2012). Such analyses require manual sampling of the salt, crushing and dividing samples, and placing samples carefully into a small pan used for either differential scanning calorimetry or differential thermal analysis.

In another approach, small samples of crystalline material are placed in sample tubes accommodated in an illuminated chamber within an aluminum sample block (i.e., the Omega, Inc. SMP30 Melting Point Apparatus), where the samples can be subjected to programmed heating and cooling cycles and their plateau (i.e., liquidus or solidus) temperatures are determined.

However, none of the existing methods is adaptable to highly radioactive salts (e.g., a molten salt) as would be found in MSRs, and their application to model the operating characteristics of a given MSR would be prohibitively expensive and time consuming. Thus, there is a need for effective, efficient and economical means of determining the liquidus temperature of a molten salt during operation of a MSR, which can deliver nearly real-time results.

### SUMMARY

It is therefore an object of the invention to provide an effective, efficient, and economical solution to determine the liquidus temperature of a molten salt, particularly, in a molten salt reactor system where the composition of the molten salt changes continuously during operation.

It is yet another object of the invention to mitigate the need for expensive computational or experimental studies to map out phase behavior of the molten salt, and to prevent costly and perhaps catastrophic salt freezes. Moreover, the invention may be applied to avoid potential zone freeze refining problems that would be encountered by immersing a probe in the larger pool of a molten salt.

In one aspect of the present invention a method for in-situ measuring of a liquidus temperature of a supply of a molten salt is disclosed which includes withdrawing a sample of the molten salt from the supply and placing it into a sample container, cooling the sample of the molten salt in the sample container from a first temperature above the liquidus temperature of the molten salt to a second temperature at which at least a portion of the sample of the molten salt solidifies, taking a plurality of temperature measurements of the sample of the molten salt during cooling of the sample from the first temperature to the second temperature, and determining the liquidus temperature of the molten salt from the plurality of temperature measurements. The method further includes heating the sample of the molten salt in the sample container from the second temperature to the first temperature, and returning the heated sample of the molten salt from the container to the supply.

In other aspects of the invention one or more of the following features may be included. The molten salt may be a molten salt nuclear fuel and the supply may be in a reactor system. The sample of the molten salt nuclear fuel may be a static sample removed from a flow of the molten salt nuclear fuel in the reactor system. The container may include a tube having proximal and distal ends and the step of withdrawing may include lowering the distal end of the tube into the molten salt nuclear fuel in the reactor system to a predetermined depth so that the molten salt nuclear fuel enters the distal end of the tube. The step of withdrawing may further include heating the tube in a sample region to the first temperature, the sample region being located between the distal and proximal ends of the tube. The step of withdrawing may include reducing a pressure within the tube proximate the proximal end of the tube relative to the distal end of the tube to cause the molten salt nuclear fuel in the tube to travel from the distal end of the tube to the sample region, the molten salt nuclear fuel in the sample region constituting the sample of the molten salt nuclear fuel.

In yet other aspects of the invention one or more of the following features may be included. The step of cooling may include using a heater to linearly with time cool the sample region from the first temperature to the second temperature, wherein at least a portion of the sample of the molten salt nuclear fuel solidifies at the second temperature. The step of taking a plurality of temperature measurements of the sample of the molten salt nuclear fuel may include using a first temperature sensor to take the plurality of temperature measurements of the sample and a second temperature sensor to take a corresponding plurality of temperature measurements of the heater during cooling of the sample from the first temperature to the second temperature. The step of determining the liquidus temperature of the molten salt nuclear fuel may include determining temperature differences between the plurality of temperature measurements of the sample and the corresponding plurality of temperature measurements of the heater; determining a first temperature point of the sample where the temperature difference starts to substantially increase; and using the first temperature point to define the liquidus temperature of a molten salt nuclear fuel in a reactor system.

In yet other aspects of the invention, the step of determining the liquidus temperature of the molten salt nuclear fuel may include comparing the plurality of temperature measurements of the sample to the corresponding plurality of temperature measurements of the heater and determining a first temperature point where the plurality of temperature measurements of the sample become substantially constant while the plurality of temperature measurements of the heater continue to decline; and wherein the step of determining may further include determining a second temperature point, lower than the first temperature, where the plurality of temperature measurements of the sample transition from being substantially constant to declining with the temperature measurements of the heater; and using the first temperature point to define the liquidus temperature of a molten salt nuclear fuel in a reactor system.

In yet other aspects of the invention one or more of the following features may be included. The step of heating may include using the heater to heat the sample region to cause the temperature of the sample of the molten salt nuclear fuel in the tube to rise from the second temperature to the first temperature and cause the sample to transition from being at least partially solidified to a liquid state. The step of returning the heated sample of the molten salt nuclear fuel from the tube to the reactor system may include increasing the pressure within the tube proximate the proximal end of the tube relative to the distal end of the tube to cause the sample of the molten salt nuclear fuel in the tube to travel from the sample region out of the distal end of the tube and into the molten salt nuclear fuel in the reactor system.

In yet other aspects of the invention one or more of the following features may be included. The method may further include interconnecting a first port of a vessel to the proximal end of the tube through a first valve and interconnecting a second end of the vessel to an external region of the nuclear reactor system through a second valve; and wherein before the step of lowering the distal end of the tube into the molten salt nuclear fuel in the reactor system, the method may include opening the first and second valves to allow gas to flow from the tube to the external region. The step of reducing the pressure within the tube proximate the proximal end of the tube relative to the distal end of the tube may include closing the first valve and opening the second valve to pump gas out of the vessel to reduce the pressure in the vessel to a level below that in the tube; the step of reducing may further include closing the second valve and opening the first valve to reduce pressure within the tube to the pressure level with the vessel to cause the molten salt nuclear fuel in the tube to travel from the distal end of the tube to the sample region and closing the first valve when the sample of the molten salt nuclear fuel is in the sample region.

In yet other aspects of the invention one or more of the following features may be included. The step of withdrawing may further include increasing a pressure outside of the distal end of the tube to cause the molten salt nuclear fuel in the tube to travel from the distal end of the tube to the sample region, the molten salt nuclear fuel in the sample region constituting the sample of the molten salt nuclear fuel. The step of cooling may include passively cooling the sample region from the first temperature to the second temperature, wherein at least a portion of the sample of the molten salt nuclear fuel solidifies at the second temperature. The step of heating may include immersing the tube with the sample of the molten salt at the second temperature into the molten salt nuclear fuel in the reactor system to heat the sample region to cause the temperature of the sample of the molten salt nuclear fuel in the tube to rise from the second temperature to the first temperature and cause the sample to transition from being at least partially solidified to being molten. The step of returning the heated sample of the molten salt nuclear fuel from the tube to the reactor system may include increasing the pressure within the tube proximate the proximal end of the tube relative to the distal end of the tube to cause the sample of the molten salt nuclear fuel in the tube to travel from the sample region out of the distal end of the tube and into the molten salt nuclear fuel in the reactor system.

In one aspect of the present invention a device for in-situ measuring of a liquidus temperature of a supply of a molten salt is disclosed which includes a sample container for holding a sample of the molten salt withdrawn from the supply, an extraction device in communication with the sample container and configured to withdraw the sample of the molten salt from the supply and place it in the sample container, and a first temperature sensor configured to measure the temperature of the sample of the molten salt in the sample container. The device further includes a control unit, the control unit configured to cause the extraction device to withdraw the sample of the molten salt from the supply and place it in the sample container, cool the sample of the molten salt in the sample container from a first temperature above the liquidus temperature of the molten salt to a second temperature at which at least a portion of the sample of the molten salt solidifies, cause the first temperature sensor to take a plurality of temperature measurements of the sample of the molten salt during cooling of the sample from the first temperature to the second temperature, determine the liquidus temperature of the molten salt from the plurality of temperature measurements, heat the sample of the molten salt in the sample container from the second temperature to the first temperature, and cause the extraction device to return the sample of the molten salt from the sample container to the supply.

In yet other aspects of the invention one or more of the following features may be included. The molten salt may be a molten salt nuclear fuel and the supply may be in a reactor system. The sample of the molten salt nuclear fuel may be a static sample removed from a flow of the molten salt nuclear fuel in the reactor system. The sample container may include a tube having proximal and distal ends and the control unit may be further configured to cause the device to lower the distal end of the tube into the molten salt nuclear fuel in the reactor system to a predetermined depth so that the molten salt nuclear fuel enters the distal end of the tube prior to withdrawing of the sample. The device may include a heater in communication with the tube, and wherein the control unit may be configured to cause the heater to heat the tube in a sample region to the first temperature prior to withdrawing of the sample, the sample region being located between the distal and proximal ends of the tube.

In yet other aspects of the invention one or more of the following features may be included. The extraction device may include a vessel having a first port interconnected to the proximal end of the tube through a first valve and a second port interconnected to an external region of the nuclear reactor system through a second valve; and wherein the control unit may be configured to open the first and second valves to allow gas to flow from the tube to the external region before lowering of the distal end of the tube into the molten salt nuclear fuel in the reactor system. The control unit may be further configured to close the first valve and open the second valve to pump gas out of the vessel to reduce the pressure in the vessel to a level below that in the tube. The control unit may be further configured to close the second valve and open the first valve to reduce pressure within the tube to the pressure level within the vessel to cause the molten salt nuclear fuel in the tube to travel from the distal end of the tube to the sample region and then to close the first valve when the sample of the molten salt nuclear fuel is in the sample region.

In yet other aspects of the invention one or more of the following features may be included. The control unit may be configured to control the heater to linearly with time cool the sample region from the first temperature to the second temperature during cooling of the sample, wherein at least a portion of the sample of the molten salt nuclear fuel may solidify at the second temperature. The device may further include a second temperature sensor and the control unit may be configured to cause the second temperature sensor to take a corresponding plurality of temperature measurements of the heater during cooling of the sample from the first temperature to the second temperature. The control unit may be configured to determine temperature differences between the plurality of temperature measurements of the sample and the corresponding plurality of temperature measurements of the heater, determine a first temperature point of the sample where the temperature difference starts to substantially increase, and use the first temperature point to define the liquidus temperature of a molten salt nuclear fuel in a reactor system. The control unit may be configured to compare the plurality of temperature measurements of the sample to the corresponding plurality of temperature measurements of the heater and determine a first temperature point where the plurality of temperature measurements of the sample become substantially constant while the plurality of temperature measurements of the heater continue to decline; and the control unit may be further configured to determine a second temperature point, lower than the first temperature, where the plurality of temperature measurements of the sample transition from being substantially constant to declining with the temperature measurements of the heater, and use the first temperature point to define the liquidus temperature of a molten salt nuclear fuel in a reactor system.

In yet other aspects of the invention one or more of the following features may be included. The control unit may be configured to control the heater to heat the sample region to cause the temperature of the sample of the molten salt nuclear fuel in the tube to rise from the second temperature to the first temperature and cause the sample to transition from being at least partially solidified to a liquid state. The control unit may be further configured to open the first and second valves to increase the pressure within the tube proximate the proximal end of the tube relative to the distal end of the tube after heating of the sample to cause the sample of the molten salt nuclear fuel in the tube to travel from the sample region out of the distal end of the tube and into the molten salt nuclear fuel in the reactor system.

In yet other aspects of the invention one or more of the following features may be included. The extraction device may include an external pressure induction system; and wherein the control unit may be configured to cause the external pressure induction system to increase a pressure outside of the distal end of the tube to cause the molten salt nuclear fuel in the tube to travel from the distal end of the tube to the sample region during withdrawing of the sample, the molten salt nuclear fuel in the sample region constituting the sample of the molten salt nuclear fuel. The control unit may be configured cause the container to passively cool the sample region from the first temperature to the second temperature during cooling of the sample, wherein at least a portion of the sample of the molten salt nuclear fuel solidifies at the second temperature.

The control unit may be configured to immerse the tube with the sample of the molten salt at the second temperature into the molten salt nuclear fuel in the reactor system to heat the sample region to cause the temperature of the sample of the molten salt nuclear fuel in the tube to rise from the second temperature to the first temperature and cause the sample to transition from being at least partially solidified to being molten during heating of the sample.

### BRIEF DESCRIPTION OF DRAWINGS

FIG. 1 is a schematic diagram depicting a molten salt reactor system.

FIG. 2 is a schematic diagram depicting the chemical processing plant of the molten salt reactor system depicted in FIG. 1.

FIGS. 3A-E arc cross-sectional views of a probe according to an embodiment of this invention at different stages of measurement.

FIGS. 4A-B are plots for determining the liquidus temperature of a molten salt using data from temperature measurements by the probe in FIGS. 3A-E.

FIG. 5 is a flow diagram depicting the operation of the probe in FIGS. 3A-E.

FIG. 6 is a cross-sectional view of a probe according to another embodiment of this invention.

### DETAILED DESCRIPTION

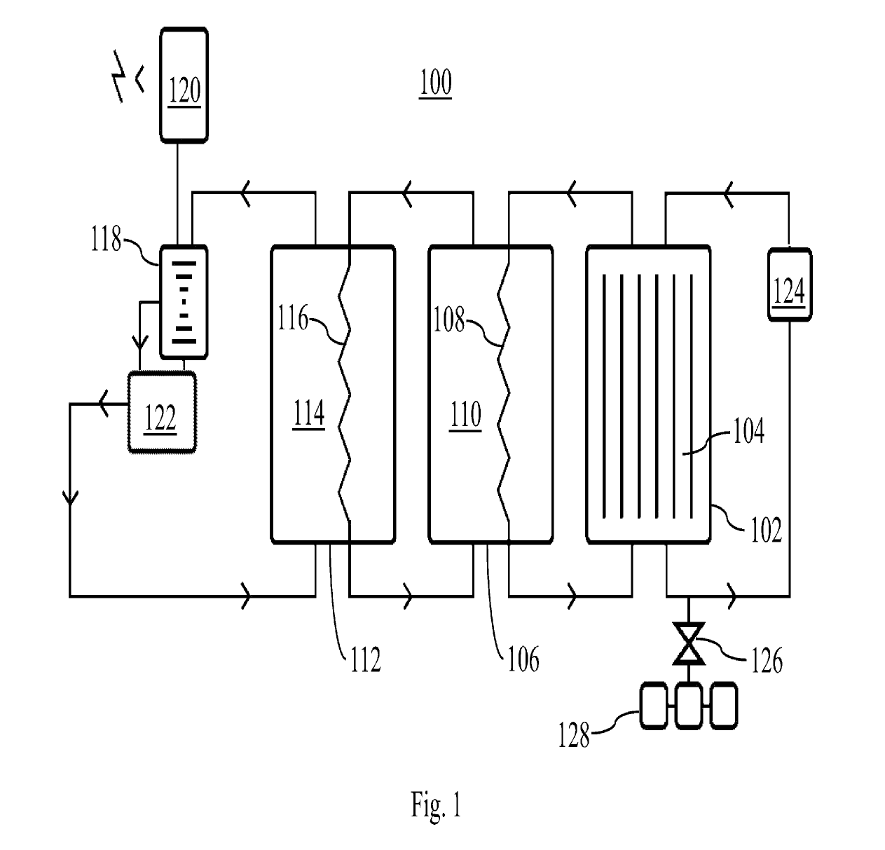

In a preferred embodiment, a molten salt reactor system 100 for the generation of electrical energy from nuclear fission is depicted in FIG. 1. System 100 includes a molten salt reactor 102 containing molten salt 104, which may include a mixture of chloride and fluoride salts. The mixture may comprise fissile materials, including thorium (Th), protactinium (Pa), uranium (U), neptunium (Np), plutonium (Pu), americium (Am), curium (Cm) (more specifically Th-225, Th-227, Th-229, Pa-228, Pa-230, Pa-232, U-231, U-233, U-235, Np-234, Np-236, Np-238, Pu-237, Pu-239, Pu-241, Am-240, Am-242, Am-244, Cm-243, Cm-245, Cm-247), and fertile materials, such as ²³²ThCl₄, ²³⁸UCl₃ and ²³⁸UCl₄. In this embodiment, the mixture comprises fissile materials including ²³³UCl₃, ²³⁵UCl₃, ²³³UCl₄, ²³⁵UCl₄, and ²³⁹PuCl₃; and carrier salts including sodium chloride (NaCl), potassium chloride (KCl), and/or calcium chloride (CaCl₂).

Upon absorbing neutrons, nuclear fission may be initiated and sustained in the fissile molten salt 104, generating heat that elevates the temperature of the molten salt 104 to, for example, approximately 650° C. 1,200° F. The heated molten salt 104 is transported via a pump (not shown) from the molten salt reactor 102 to a heat exchange unit 106, which is configured to transfer the heat generated by the nuclear fission from the molten salt 104.

The transfer of heat from salt 104 may be realized in various ways. For example, the heat exchange unit 106 may include a pipe 108, through which the heated molten salt 104 travels, and a secondary fluid 110 (e.g., a coolant salt) that surrounds the pipe 108 and absorbs heat from the molten salt 104. Upon heat transfer, the temperature of the molten salt 104 is reduced in the heat exchange unit 106 and the molten salt 104 is transported from the heat exchange unit 106 back to the molten salt reactor 102. A secondary heat exchange unit 112 may be included to transfer heat from the secondary fluid 110 to a tertiary fluid 114 (e.g., water), as fluid 110 is circulated through secondary heat exchange unit 112 via a pipe 116.

The heat received from the molten salt 104 may be used to generate power (e.g., electric power) using any suitable technology. For example, the water in the secondary heat exchange unit 112 is heated to a steam and transported to a turbine 118. The turbine 118 is turned by the steam and drives an electrical generator 120 to produce electricity. Steam from the turbine 118 is conditioned by an ancillary gear 122 (e.g., a compressor, a heat sink, a pre-cooler, and a recuperator) and transported back to the secondary heat exchange unit 112. Alternatively, the heat received from the molten salt 104 may be used in other applications such as nuclear propulsion (e.g., marine propulsion), desalination, domestic or industrial heating, hydrogen production, or a combination thereof.

During the operation of the molten salt reactor 102, fission products will be generated in the molten salt 104. The fission products will include a range of elements. In this preferred embodiment, the fission products may include, but are not limited to, rubidium (Rb), strontium (Sr), cesium (Cs), barium (Ba), an element selected from lanthanides, palladium (Pd), ruthenium (Ru), silver (Ag), molybdenum (Mo), niobium (Nb), antimony (Sb), technetium (Tc), Xenon (Xe) or Krypton (Kr).

The buildup of fission products (e.g., radioactive noble metals and radioactive noble gases) in molten salt 104 may impede or interfere with the nuclear fission in the molten salt reactor 102 by poisoning the nuclear fission. For example, xenon-135 and samarium-149 have a high neutron absorption capacity, and may lower the reactivity of the molten salt. Fission products may also reduce the useful lifetime of the molten salt reactor 102 by clogging components, such as heat exchangers or piping.

Therefore, it is generally necessary to keep concentrations of fission products in the molten salt 104 below certain thresholds to maintain proper functioning of the reactor 102. This may be accomplished by a chemical processing plant 124 configured to remove at least a portion of fission products generated in the molten fuel salt 104 during nuclear fission. During operation, molten salt 104 is transported from the molten salt reactor 102 to the chemical processing plant 124, which may processes the molten salt 104 so that the molten salt reactor 102 functions without loss of efficiency or degradation of components. An actively cooled freeze plug 126 is included and configured to allow the molten salt 104 to flow into a set of emergency dump tanks 128 in case of power failure or on active command.

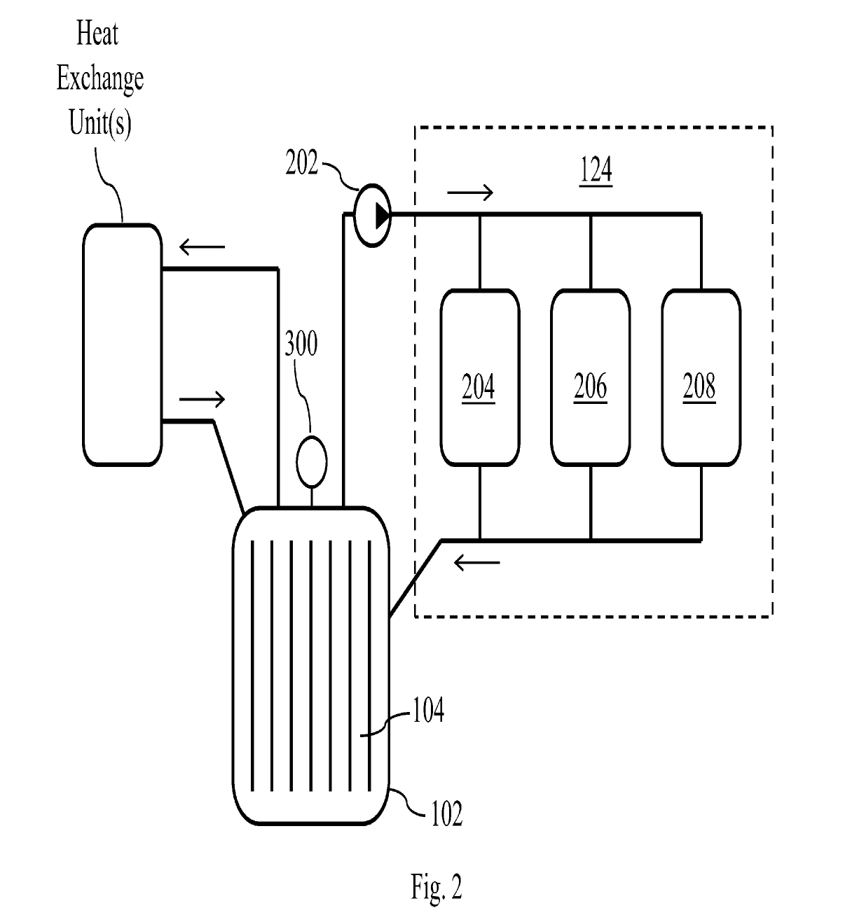

FIG. 2 shows additional detail of the chemical processing plant 124. During a typical state of reactor operation, the molten salt 104 can be circulated continuously (or near-continuously) by way of pump 202 from the molten salt reactor 102 through one or more of the functional sub-units of the chemical processing plant 124. In addition to removing fission products, the chemical processing plant 124 is also configured to limit or reduce the corrosion of the molten salt reactor 102 by the molten salt 104 by way of a corrosion reduction unit 204, FIG. 2.

The chemical processing plant 124 also includes a froth flotation unit 206 configured to remove at least part of the insoluble fission products (e.g., krypton (Kr), Xenon (Xe), palladium (Pd), ruthenium (Ru), silver (Ag), molybdenum (Mo), niobium (Nb), antimony (Sb), technetium (Tc)) from molten salt 104. Froth flotation unit 206 is also configured to remove at least part of the dissolved gas fission products (e.g., Xenon (Xe) or Krypton (Kr)). The froth flotation unit 206 generates froth from the molten salt 104 that includes insoluble fission products and dissolved gas fission products. The dissolved gas fission products are removed from the froth, and at least a portion of the insoluble fission products are removed by filtration.

Also included in chemical processing plant 124 is salt exchange unit 208 which is configured to remove at least a portion of the fission products (e.g., rubidium (Rb), strontium (Sr), cesium (Cs), barium (Ba), and an element selected from lanthanides) soluble in the molten salt 104. The removal of soluble fission products may be realized through various mechanisms.

As indicated above, in order to limit corrosion of the molten salt reactor 102, the chemical processing plant 124 includes a corrosion reduction unit 204 configured to protect the corrosion of the molten salt reactor 102 by the molten salt 104. The molten salt reactor 102 is typically constructed of metallic alloy including one or more of the following elements: iron (Fe), nickel (Ni), chromium (Cr), manganese (Mn), carbon (C), silicon (Si), niobium (Nb), titanium (Ti), vanadium (V), phosphorus (P), sulfur (S), molybdenum (Mo), or nitrogen (N). The molten salt 104 may include uranium tetrachloride (UCl₄), which can corrode the molten salt reactor 102 by oxidizing chromium (Cr→Cr²⁺+2e−; Cr+2UCl₄→CrCl₂+2UCl₃).

During reactor operation, the molten salt 104 is transported from the reactor 102 to the corrosion reduction unit 204 and from the corrosion reduction unit 204 back to the reactor 102. The transportation of the molten salt 104 may be driven by pump 202, which may be configured to adjust the rate of transportation. The corrosion reduction unit 204 is configured to process the molten salt 104 to maintain an oxidation reduction (redox) ratio, E(o)/E(r), in the molten salt 104 in the molten salt reactor 102 (and elsewhere throughout the system) at a substantially constant level, wherein E(o) is an element (E) at a higher oxidation state (o) and E(r) is the element (E) at a lower oxidation state (r).

During operation of the molten salt reactor system 100, the temperature of the molten salt 104 needs to be maintained above its liquidus temperature to prevent solidification of the molten salt 104. Therefore, it may be important to obtain real-time liquidus temperature of the molten salt 104, which often varies over time due to the changing composition of the molten salt 104. A probe 300 is disposed in the molten salt reactor system 100, preferably in a position (e.g., the headspace of a molten salt reactor 102) to access the molten salt 104 during operation of the molten salt reactor system 100.

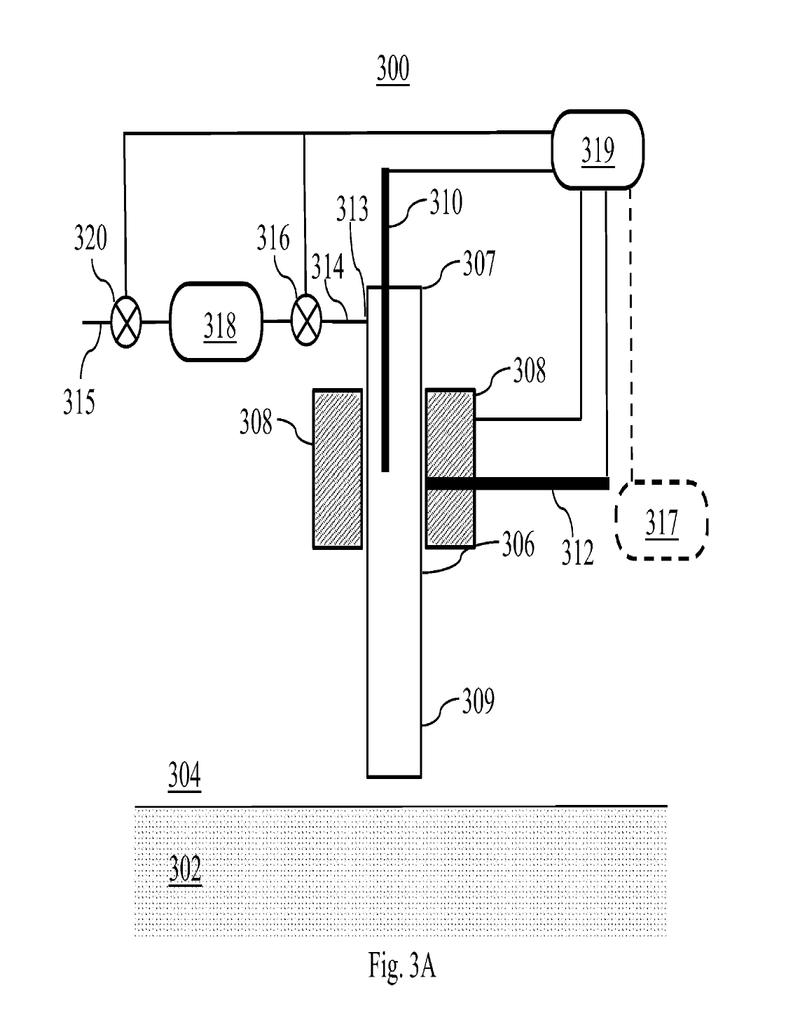

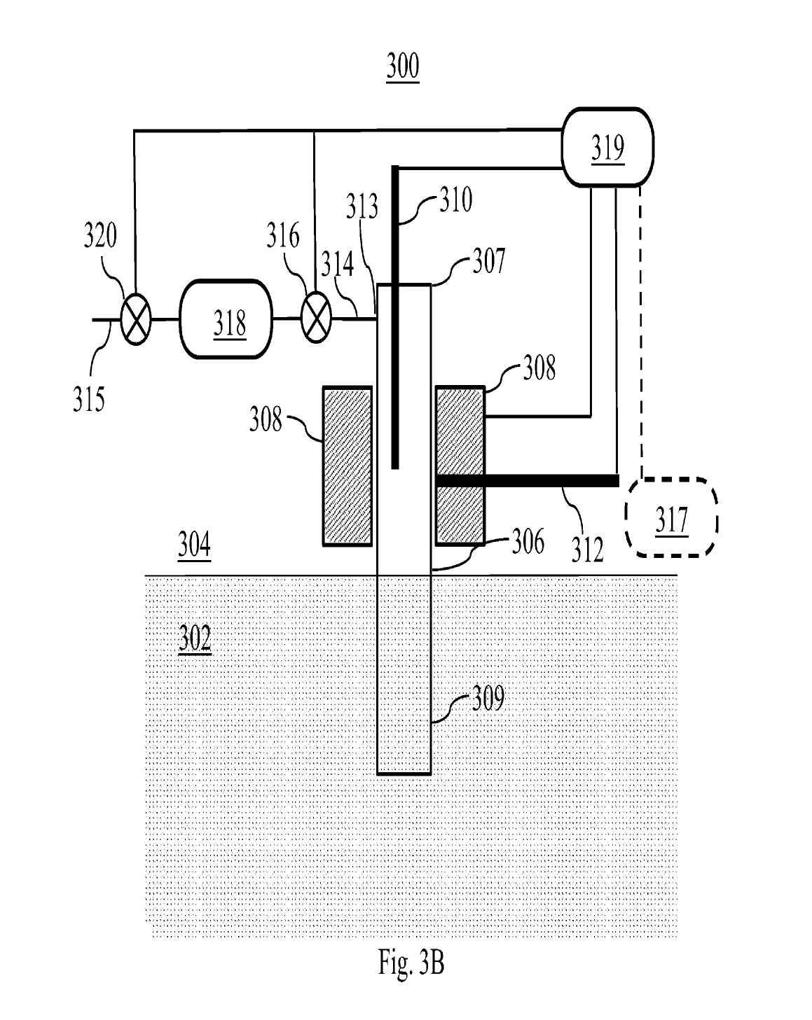

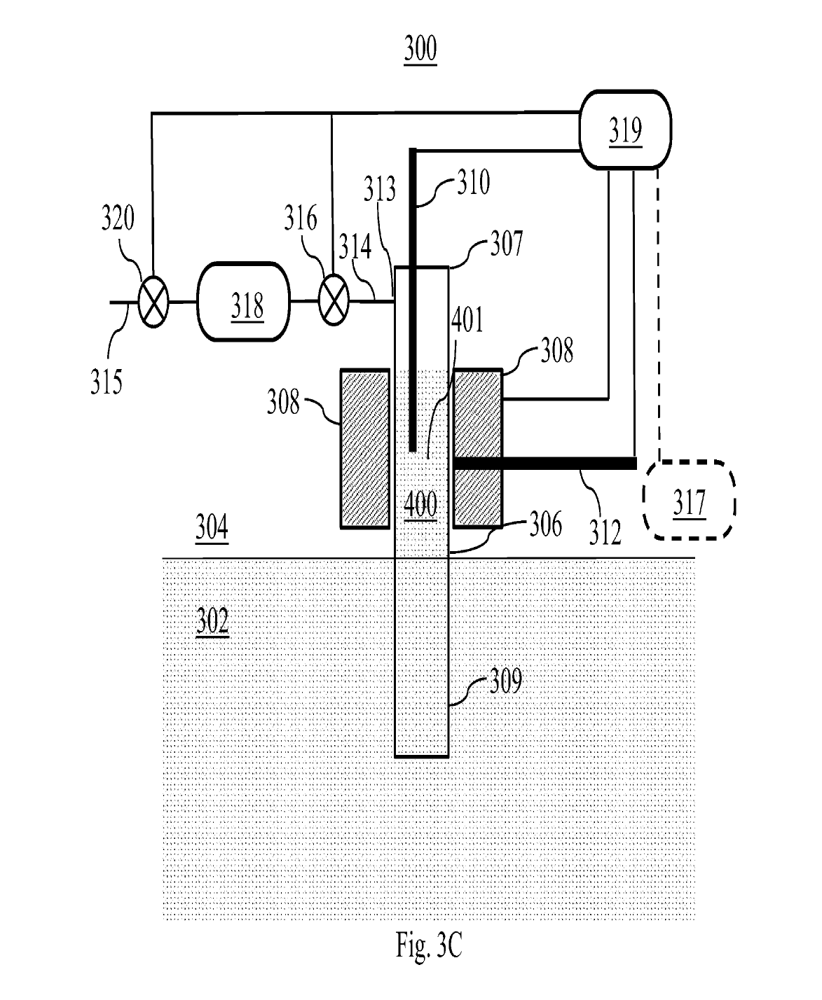

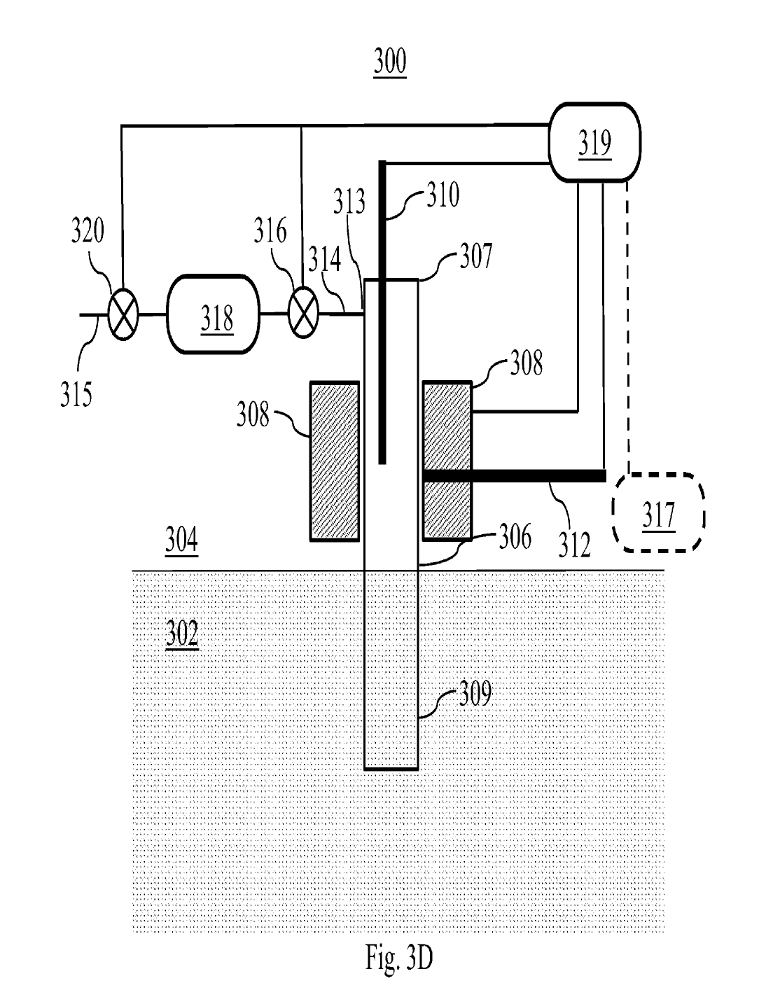

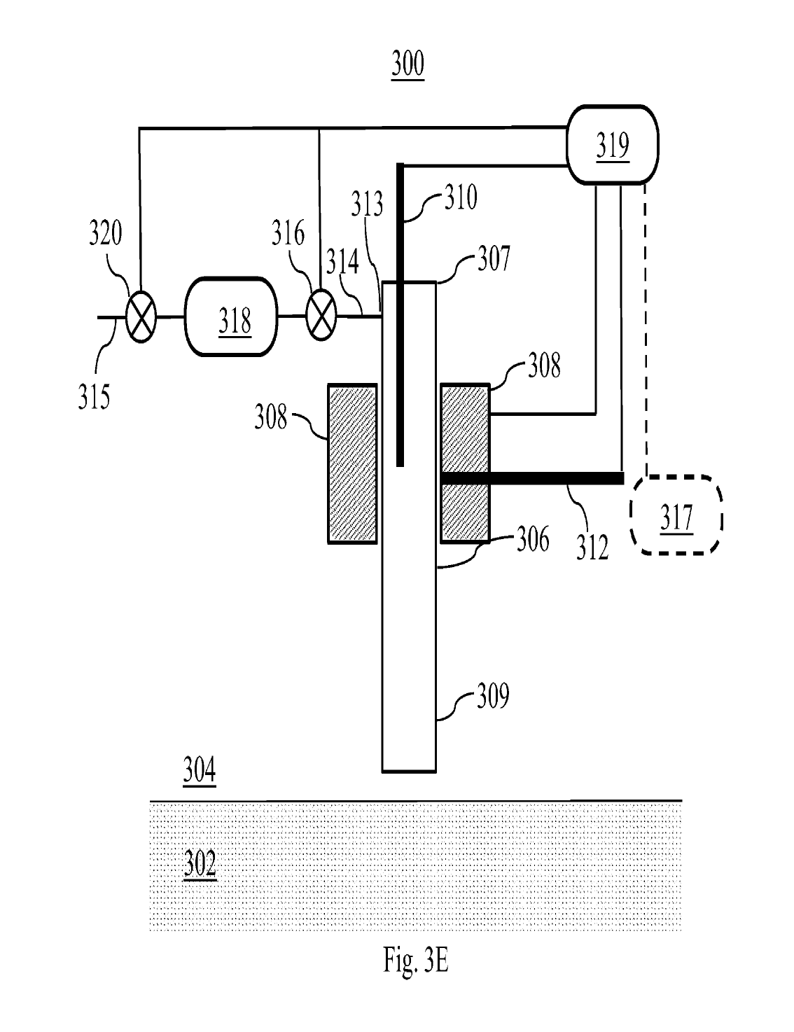

FIGS. 3A-E further illustrate a preferred embodiment of the probe 300. The probe 300 is configured to withdraw a sample 400 (FIG. 3C) from a molten salt pool 302, measure the liquidus temperature of the sample 400, and return the sample 400 to the molten salt pool 302. In various embodiments, the probe 300 may be permanently installed through a surface of a vessel or a pipe in the molten salt reactor system 100, or be inserted as a detachable device (e.g., via a feedthrough into a gas headspace above a portion of the molten salt 104).

During a typical measurement, the molten salt pool 302 (whose liquidus temperature is to be measured) is surmounted by a gas phase 304 (e.g., gas contained within the headspace of a molten salt reactor 102). The molten salt pool 302 is flowing at sufficiently low velocity with respect to the probe 300 so that splashing, bow-wave formation and other hydrodynamic effects are negligible to the probe 300. In other embodiments, the molten salt pool 302 may be static.

The probe 300 includes a tube 306 within in which the sample 400 is held, an internal thermocouple 310 configured to measure the temperature of the sample 400, and a furnace 308 configured to heat a portion of the tube 306 and the sample 400 therein. The tube 306 (preferably cylindrical in shape) includes a proximal end 307, and a distal end 309, through which the sample 400 enters the tube 306.

The probe 300 is further configured to induce a pressure difference between the proximal end 307 and the distal end 309 of the tube 306. Probe 300 includes a tank 318, a first pressure line 314 through which gas travels between the tank 318 and the proximal end 307, and a second pressure line 315 through which gas travels between the tank 318 and the atmosphere or other components (e.g., one or more valves or a pump). The first pressure line 314 is in communication with the proximal end 307 through a gas port 313. The probe 300 further includes a first valve 316 configured to control gas flow through the pressure line 314 and a second valve 320 configured to control gas flow through the second pressure line 315. A control unit 319 is included in the probe 300 and configured to control the first valve 316 and second valve 320 independently, as well as to control the overall operation of probe 300.

Alternative or additional embodiments to create the pressure difference between the proximal end 307 and distal end 309 of the tube 306 are considered within the scope of the invention. For example, the probe 300 may include an external pressure induction system 317 configured to increase the pressure of the gas phase 304 to a level higher than in the tube 306. The external pressure induction system 317 may be controlled by the control unit 319.

At the beginning of the measurement, FIG. 3A, the probe 300 is positioned so that the distal end 309 of the tube 306 resides in the gas phase 304 and is not in contact with the molten salt pool 302. The first valve 316 and second valve 320 are open, allowing the communication between the proximal end 307 of the tube 306 and a body of gas (e.g., the atmosphere) that at around the same pressure as the gas phase 304.

As shown in FIG. 3B, the probe 300 is then lowered to a position so that at least a portion of distal end 309 of the tube 306 is submerged in the molten salt pool 302, but the internal thermocouple 310 is not in contact with the molten salt pool 302. The lowering of probe 300 may be monitored (e.g., by a sensor not shown) and controlled so that tube 309 is submerged to a target depth.

During the lowering of the probe 300, a portion of the molten salt pool 302 enters the tube 306 through the distal end 309. Since the first valve 316 and second valve 320 are open, gas in the proximal end 307 of the tube 306 exits through the first pressure line 314 as the probe 300 is lowered. The surface of the molten salt within the tube 306 is maintained at the same level as the surface of the molten salt pool 302. Upon lowering of the probe 300, the gas trapped in the proximal end 307 of the tube 306 stabilizes at the pressure in the pressure line 314 (e.g., the pressure of the gas phase 304).

The first valve 316 is then closed, and the gas within the tank 318 is then withdrawn (e.g., by a pump through the second pressure line 315). As a result, the pressure within the tank 318 is lower than the pressure within the distal end 309 of the tube 306. The second valve 320 is then closed, and the furnace 308 heats a portion of the tube 306 to a temperature at or above the temperature of the molten salt pool 302.

Referring to FIG. 3C, the first valve 316 is then opened, allowing gas to exit from the tube 306 into the tank 318 through the first pressure line 314. Since the gas pressure within the tube 306 is lower than the pressure of the gas phase 304, a sample 400 of the molten salt is drawn into the tube 306 from the distal end 309 towards the proximal end 307 and occupies sample region 401. The volume of the sample region 401 may be adjusted by controlling the reduced gas pressure within the tank 318 (e.g., by controlling the close of the second valve 320). Preferably, the sample 400 immerses at least a portion of the internal thermocouple 310 to allow the temperature measurement of the sample 400 by the internal thermocouple 310 (monitored by the control unit 319), and the sample 400 does not immerse the gas port 313 so that the sample 400 does not enter the first pressure line 314. The first valve 316 is then closed, isolating the tube 306 from the tank 318.

The temperature of the furnace 308 is gradually lowered (e.g., linearly with time) from the initial temperature, i.e. the temperature of the molten salt pool 302, thus the temperature in sample region 401 and the sample 400 therein are likewise lowered. As a result, the sample 400 is cooled from a first temperature above the liquidus temperature of the sample 400 to a second temperature at which at least a portion of the sample 400 solidifies. A furnace thermocouple 312 is included to monitor the temperature of the furnace 308, and the control unit 319 is further configured to receive the monitored temperature from the furnace thermocouple 312 and control the temperature of the furnace 308 (e.g., by controlling the power input of the furnace 308).

During the cooling process, a plurality of temperature measurements of the sample 400 are taken by the interior thermocouple 310, while a plurality of temperature measurements of the furnace 308 arc performed by the furnace thermocouple 312. The two sets of measured temperatures (by the interior thermocouple 310 and by the furnace thermocouple 312) may be compared over time.

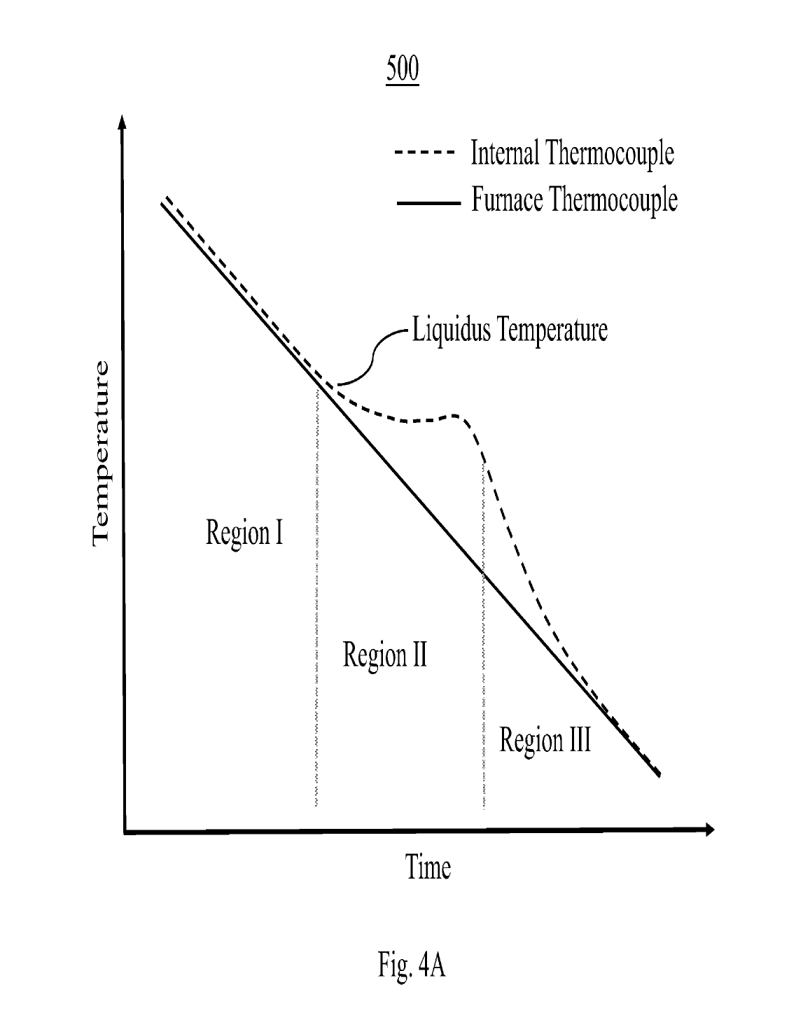

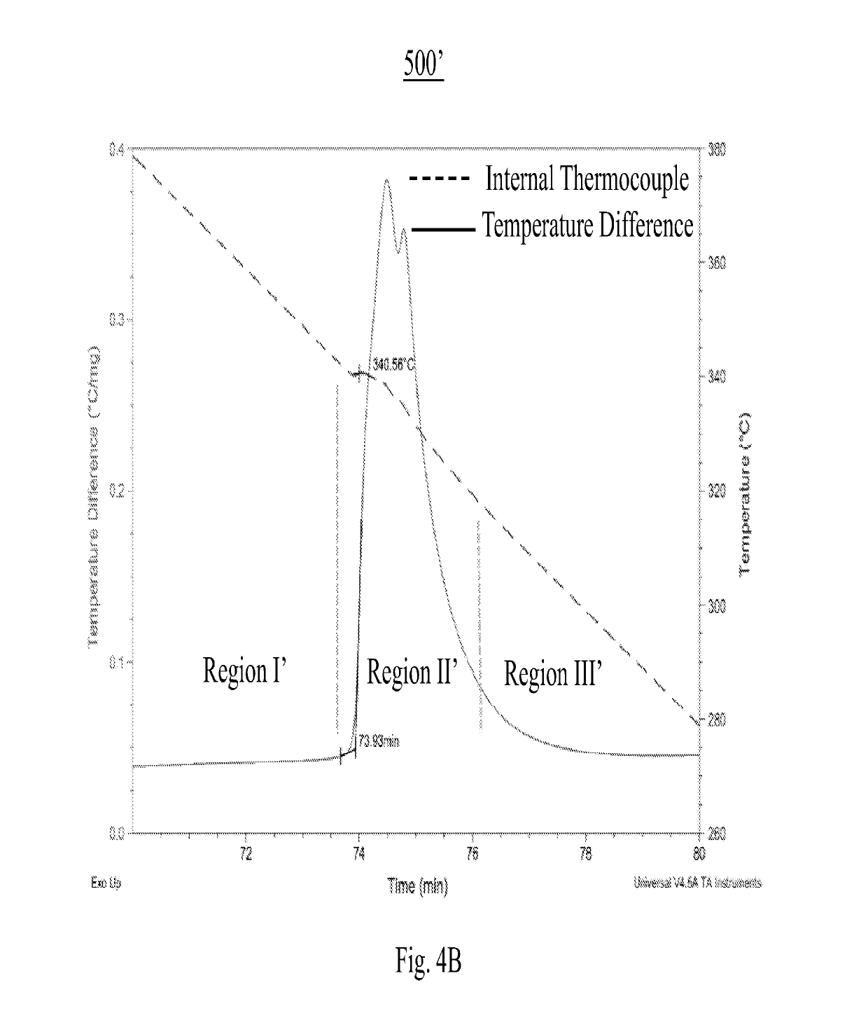

FIG. 4A shows a typical temperature-time plot 500 that may be used for the comparison of the two sets of measured temperatures. In the plot 500, the two sets of measured temperatures are independently plotted. At the beginning of the cooling (region I in plot 500), the sample 400 is a liquid, and the two sets of measured temperatures reduce at a similar rate (e.g., the two sets of measured temperatures closely track). As the temperature of the sample 400 reaches its liquidus temperature, at least a portion of the sample 400 begins to solidify. The measured temperatures by the internal thermocouple 310 level off (“plateau”, region II in plot 500) compared to the measured temperatures by the furnace thermocouple 312, which continues to linearly decline. Upon further cooling the sample 400, two sets of measured temperatures then begin to approximate each other and decline as determined by the furnace 308 (region III in plot 500). Upon cooling to the second temperature, the sample 400 at least partially solidifies, and preferably, the sample 400 completely solidifies. The liquidus temperature of the molten salt pool 302 may be determined by control unit 319 by identifying a temperature at which the two sets of measured temperatures start to diverge from each other (i.e. plateau region II).

FIG. 4B shows a typical plot 500′ that may be alternatively used for the comparison of the two sets of measured temperatures. In plot 500′, the difference between the two sets of temperatures is plotted over time, and independently, the set of temperatures measured by the internal thermo couple 306 is plotted over time. At the beginning of the cooling (region I′ in plot 500′), the sample 400 is a liquid, and the temperature difference maintains at a low level. As the temperature of the sample 400 reaches its liquidus temperature, at least a portion of the sample 400 begins to solidify, resulting in an increased temperature difference (“peak”, region II' in plot 500′). Upon further cooling the sample 400, the sample 400 is a liquid, and the temperature difference reduces to a low level (region III′ in plot 500′). The liquidus temperature of the molten salt pool 302 may be determined by control unit 319 by identifying a temperature at which the temperature difference starts to increase (the peak starts to form, e.g., 340.56° C. at 73.93 min); the temperature can be calculated by performing a linear extrapolation of the peak back to the baseline.

Referring to FIG. 3D, upon completion of the temperature measurements, the furnace 308 then heats the sample region 401 of the tube 306 and the sample 400 therein to the first temperature so that the sample 400 liquefies. The first valve 316 and the second valve 320 are then opened to allow the gas pressure within the tube 306 to reach a similar pressure of the gas phase 304, thereby releasing the sample 400 from the sample region 401 into the molten salt.

The probe 300, FIG. 3E, is then lifted to a position so that the distal end 309 resides in the gas phase 304 and is not in contact with the molten salt pool 302. Preferably, the probe 300 is lifted to the same position as at the beginning of the measurement. Gas pressure within the tube 306 continues to equilibrate throughout the lifting of the probe 300 so that at least a majority of the molten salt exits from the tube 306 into the molten salt pool 302 through the distal end 309.

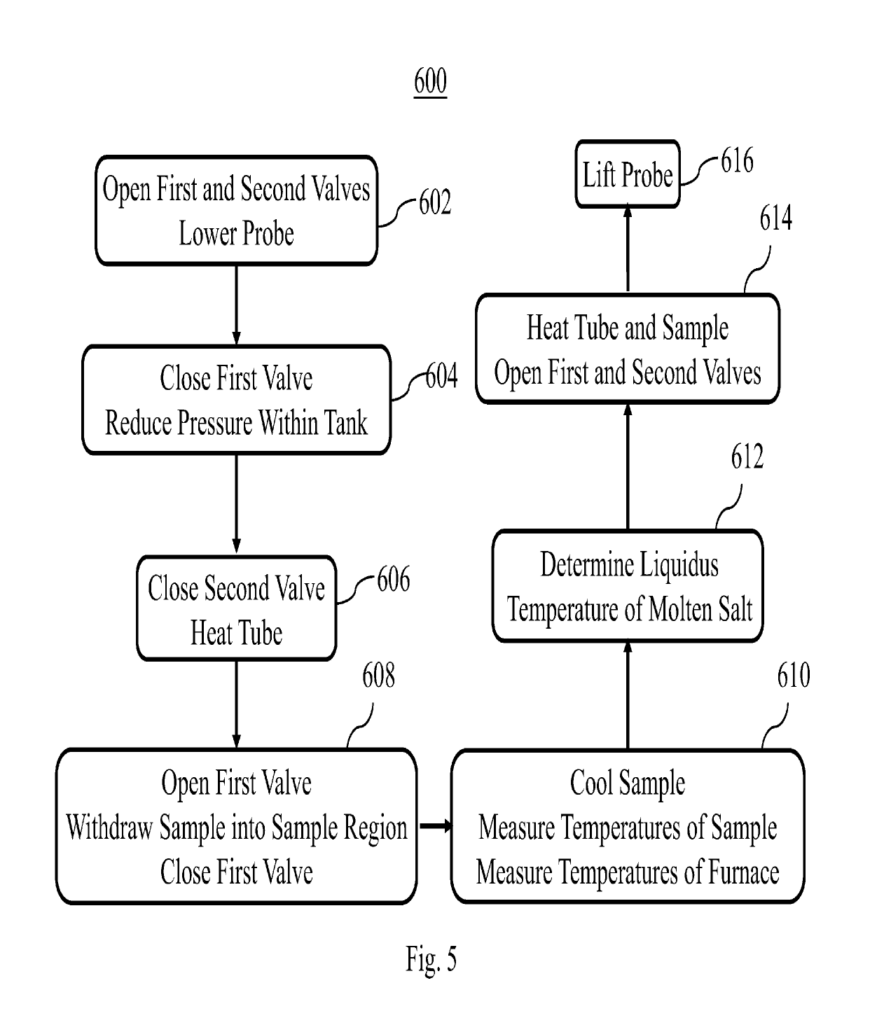

A flow diagram 600, FIG. 5, further illustrates the operations of the probe 300 controlled by the control unit 319. As a first step, 602, both of the first valve 316 and the second valve 320 are opened and the probe 300 is lowered to a position so that at least a portion of distal end 309 of the tube 306 is submerged in the molten salt pool 302. However, the internal thermocouple 310 is not in contact with the molten salt pool 302.

At step 604, the first valve 316 is closed, isolating the tank 318 from the tube 306 while the second valve 320 remains open and the pressure within the tank 318 is then reduced by withdrawing gas from the tank 318. Next, in step 606, the second valve 320 is closed and the furnace 308 heats the sample region 400 of the tube 306 to a temperature at or above the temperature of the molten salt pool 302. At step 608, the first valve 316 is opened, the sample 400 is withdrawn into the sample region 401 and then the first valve 316 is closed.

In step 610, the sample 400 is cooled from a first temperature to a second temperature, and a plurality of temperature measurements of both the sample 400 and the furnace 308 are taken during the cooling. The two sets of measured temperatures are compared to determine the liquidus temperature of the molten salt pool 302 in step 612. In step 614, the furnace 308 heats the tube 306 and the sample 400 therein, and both of the first valve 316 and the second valve 320 are opened to return the sample 400 from the sample region 401 into the molten salt. Finally, the probe 300 is lifted to a position so that the distal end 309 resides in the gas phase 304 and is not in contact with the molten salt pool 302, step 616.

The in-situ measurement of the liquidus temperature of the molten salt pool 302 as described above may be repeated. The repeated measurements may allow the monitoring of the liquidus temperature of the molten salt pool 302 in real-time, and preferably, to further determine the affect of the changes of the molten salt composition to its liquidus temperature. The composition of the molten salt 104 may then be changed (e.g., by adding substance to the composition of the molten salt 104) in order to adjust the liquidus temperature of the molten salt 104 to a desired level.

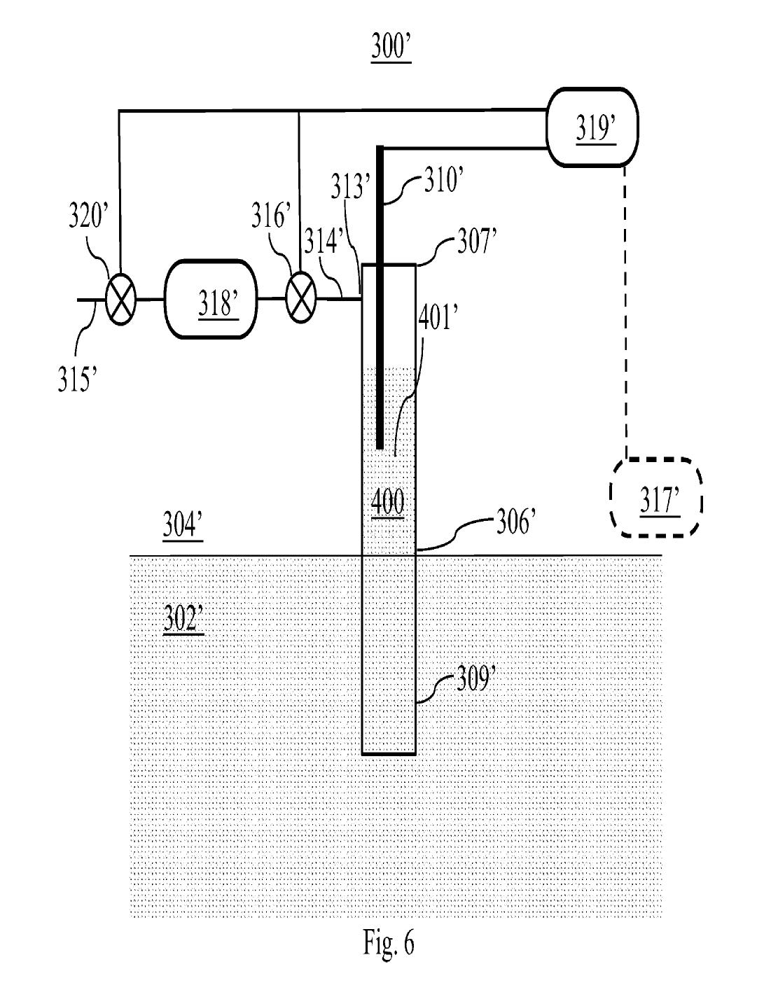

FIG. 6 illustrates another embodiment of the probe 300′ according to this invention. The probe 300′ does not include the furnace 308 and furnace thermocouple 312 of the probe 300 as depicted in FIG. 4A-E. Additionally, the tube 306′ included in the probe 300′ carries sufficient volume so that the sample 400′ cools slowly enough to allow the determination of its liquidus temperature from a plateau observed in the set of measured temperatures of the sample 400′. The cooled sample 400′ may be returned to the molten salt pool 302′, or alternatively, the cooled sample 400′ may be discarded or recovered.

In other embodiments, returning the sample 400 (400′) to the molten salt pool 302 (302′) may be accomplished by removing the tube 306 (306′) from the molten salt reactor 102 (102′), heating the tube 306 (306′) or processing the tube 306 (306′) to remove the sample 400, and returning the remove sample 400 (400′) to the molten salt pool 302 (302′).

Alternatively, the tube 306 (306′) may be further lowered to submerge the sample region 401 (401′) into the molten salt pool 302 (302) upon completion of temperature measurements, so that the sample 400 (400′) therein liquefies. The tube 306 (306′) may then be lifted from the molten salt pool 302 (302′) to allow the molten salt exit from the tube 306 (306′) to the molten salt pool 302 (302′).

A particular implementation has been described above. Nevertheless, it will be understood that various modifications may be made. Accordingly, other implementations are within the scope of the following claims.

What is claimed is:

1. A method for in-situ measuring of a liquidus temperature of a supply of a molten salt, comprising:
withdrawing a sample of the molten salt from the supply and placing it into a sample container;
cooling the sample of the molten salt in the sample container from a first temperature above the liquidus temperature of the molten salt to a second temperature at which at least a portion of the sample of the molten salt solidifies;
taking a plurality of temperature measurements of the sample of the molten salt during cooling of the sample from the first temperature to the second temperature;
determining the liquidus temperature of the molten salt from the plurality of temperature measurements;
heating the sample of the molten salt in the sample container from the second temperature to the first temperature; and
returning the heated sample of the molten salt from the container to the supply.

2. A device for in-situ measuring of a liquidus temperature of a supply of a molten salt, comprising:
a sample container for holding a sample of the molten salt withdrawn from the supply;
an extraction device in communication with the sample container and configured to withdraw the sample of the molten salt from the supply and place it in the sample container;
a first temperature sensor configured to measure the temperature of the sample of the molten salt in the sample container; and
a control unit, the control unit configured to:
cause the extraction device to withdraw the sample of the molten salt from the supply and place it in the sample container;
cool the sample of the molten salt in the sample container from a first temperature above the liquidus temperature of the molten salt to a second temperature at which at least a portion of the sample of the molten salt solidifies;
cause the first temperature sensor to take a plurality of temperature measurements of the sample of the molten salt during cooling of the sample from the first temperature to the second temperature;
determine the liquidus temperature of the molten salt from the plurality of temperature measurements;
heat the sample of the molten salt in the sample container from the second temperature to the first temperature; and
cause the extraction device to return the sample of the molten salt from the sample container to the supply.

3. The device of claim 2 wherein the molten salt is a molten salt nuclear fuel and the supply is in a reactor system.

4. The device of claim 3 wherein the sample of the molten salt nuclear fuel is a static sample removed from a flow of the molten salt nuclear fuel in the reactor system.

5. The device of claim 4 wherein the sample container comprises a tube having proximal and distal ends and the control unit is further configured to cause the device to lower the distal end of the tube into the molten salt nuclear fuel in the reactor system to a predetermined depth so that the molten salt nuclear fuel enters the distal end of the tube prior to withdrawing of the sample.

6. The device of claim 5 wherein the device includes a heater in communication with the tube, and wherein the control unit is configured to cause the heater to heat the tube in a sample region to the first temperature prior to withdrawing of the sample, the sample region being located between the distal and proximal ends of the tube.

7. The device of claim 6 wherein the extraction device includes a a vessel having a first port interconnected to the proximal end of the tube through a first valve and a second port interconnected to an external region of the nuclear reactor system through a second valve; and
wherein the control unit is configured to open the first and second valves to allow gas to flow from the tube to the external region before lowering of the distal end of the tube into the molten salt nuclear fuel in the reactor system.

8. The device of claim 7 wherein the control unit is further configured to close the first valve and open the second valve to pump gas out of the vessel to reduce the pressure in the vessel to a level below that in the tube.

9. The device of claim 8 wherein the control unit is further configured to close the second valve and open the first valve to reduce pressure within the tube to the pressure level within the vessel to cause the molten salt nuclear fuel in the tube to travel from the distal end of the tube to the sample region and then to close the first valve when the sample of the molten salt nuclear fuel is in the sample region.

10. The device of claim 9 wherein the control unit is configured to control the heater to linearly with time cool the sample region from the first temperature to the second temperature during cooling of the sample, wherein at least a portion of the sample of the molten salt nuclear fuel solidifies at the second temperature.

11. The device of claim 10 wherein the device further includes a second temperature sensor and the control unit is configured to cause the second temperature sensor to take a corresponding plurality of temperature measurements of the heater during cooling of the sample from the first temperature to the second temperature.

12. The device of claim 11 wherein the control unit is configured to determine temperature differences between the plurality of temperature measurements of the sample and the corresponding plurality of temperature measurements of the heater, determine a first temperature point of the sample where the temperature difference starts to substantially increase, and use the first temperature point to define the liquidus temperature of a molten salt nuclear fuel in a reactor system.

13. The device of claim 11 wherein the control unit is configured to compare the plurality of temperature measurements of the sample to the corresponding plurality of temperature measurements of the heater and determine a first temperature point where the plurality of temperature measurements of the sample become substantially constant while the plurality of temperature measurements of the heater continue to decline; and the control unit is further configured to determine a second temperature point, lower than the first temperature, where the plurality of temperature measurements of the sample transition from being substantially constant to declining with the temperature measurements of the heater, and use the first temperature point to define the liquidus temperature of a molten salt nuclear fuel in a reactor system.

14. The device of claim 12 wherein the control unit is configured to control the heater to heat the sample region to cause the temperature of the sample of the molten salt nuclear fuel in the tube to rise from the second temperature to the first temperature and cause the sample to transition from being at least partially solidified to a liquid state.

15. The device of claim 14 wherein the control unit is further configured to open the first and second valves to increase the pressure within the tube proximate the proximal end of the tube relative to the distal end of the tube after heating of the sample to cause the sample of the molten salt nuclear fuel in the tube to travel from the sample region out of the distal end of the tube and into the molten salt nuclear fuel in the reactor system.

16. The device of claim 5 wherein the extraction device includes an external pressure induction system; and wherein the control unit is configured to cause the external pressure induction system to increase a pressure outside of the distal end of the tube to cause the molten salt nuclear fuel in the tube to travel from the distal end of the tube to the sample region during withdrawing of the sample, the molten salt nuclear fuel in the sample region constituting the sample of the molten salt nuclear fuel.

17. The device of claim 6 wherein the control unit is configured cause the container to passively cool the sample region from the first temperature to the second temperature during cooling of the sample, wherein at least a portion of the sample of the molten salt nuclear fuel solidifies at the second temperature.

18. The device of claim 6 wherein the control unit is configured to immerse the tube with the sample of the molten salt at the second temperature into the molten salt nuclear fuel in the reactor system to heat the sample region to cause the temperature of the sample of the molten salt nuclear fuel in the tube to rise from the second temperature to the first temperature and cause the sample to transition from being at least partially solidified to being molten during heating of the sample.
